(19) United States
(12) Patent Application Publication
(10) Pub. No.: US 2007/0293242 A1
(43) Pub. Date: Dec. 20, 2007

(54) Communication device location specifying system and location specifying device

(75) Inventor: Nobuyuki Nonaka, Tokyo (JP)

Correspondence Address: SNIDER & ASSOCIATES, P. O. BOX 27613, WASHINGTON, DC, 20038-7613, US

(73) Assignees: Aruze Corp., Tokyo (JP); Seta Corp., Tokyo (JP)

(21) Appl. No.: 11/808,674

(22) Filed: Jun. 12, 2007

(30) Foreign Application Priority Data
Jun. 14, 2006 (JP) 2006-164404

(51) Int. Cl. H04Q 7/20

(52) U.S. Cl. 455/456.1

(57) ABSTRACT

A communication device location specifying system has a plurality of wireless communication devices, a location specifying device that specifies locations of the plurality of wireless communication devices, and a plurality of access points that are wirelessly connected to the plurality of wireless communication devices and relay the exchange of data between each wireless communication device and the location specifying device. Each of the wireless communication devices measures the intensity of an electric wave received from each of the access points, and transmits electric wave intensity measurement data indicating the measured intensity of the electric wave to the location specifying device via the access point, and the location specifying device calculates the locations of the plurality of wireless communication devices on the basis of the electric wave intensity measurement data.

### RELATED APPLICATIONS

This application claims the priority of Japanese Patent Application No. 2006-164404 filed on Jun. 14, 2006, which is incorporated herein by reference.

### BACKGROUND OF THE INVENTION

1. Field of the Invention

The present invention relates to a communication device location specifying system and a location specifying device, and more particularly to a communication device location specifying system and a location specifying device that manage the location of intercoms or other wireless communication devices operated by clerks of a game arcade or the like, and transmit an instruction or the like to the clerks in accordance with the locations of the intercoms.

2. Description of the Prior Art

In the case where a game player plays a game on a gaming machine (pachinko machine, slot machine, video game machine, or other gaming machine) at a game arcade or the like, it is conventional that the game player frequently calls out a clerk or staff of the game arcade for various reasons to get some sort of assistant. When, for example, there is a trouble on a gaming machine, such as clogging with balls, or in the case of need of a container called “coin bucket” when hitting a jackpot, the game player frequently needs a staff to rush to the machine to solve the problems.

In order to respond to such circumstances, there is usually a device or system in a game arcade that a game player uses to call out a staff. For example, there is suggested a system in which an indication lamp is provided on the top of a gaming machine, and this indication lamp is activated so that, when a call signal for calling out a clerk is sent from the gaming machine, the gaming machine sending the call signal can be confirmed from a long distance (Japanese Unexamined Patent Publication No. 2005-177356, for example).

In such system, however, in the case where there are a plurality of clerks at a location where the blinking of the indication lamp for calling a staff can be seen, the plurality of clerks may rush to the gaming machine that is calling, resulting in low operating efficiency of the clerks. In such a case, it is preferred to specify a clerk proximate to a calling gaming machine and to instruct the clerk to rush to the gaming machine, but conventional indication systems such as the one described above were not capable of realizing such processing.

### SUMMARY OF THE INVENTION

It is an object of the present invention to provide a communication device location specifying system and location specifying device that specifies a clerk who is in the best location to rush to a gaming machine calling for a clerk (the nearest position to the gaming machine, or a position in a pathway to reach the gaming machine most quickly), and cause the clerk to rush to the gaming machine.

The present invention has the following characteristics as a way to solve the problems described above.

A first aspect of the present invention is proposed as communication device location specifying system for specifying a clerk who is in the best location to rush to a gaming machine calling for a clerk (the nearest position to the gaming machine, or a position in a pathway to reach the gaming machine most quickly), and causing the clerk to rush to the gaming machine.

This communication device location specifying system has a plurality of wireless communication devices (e.g., intercoms, mobile communication terminals, or the like), location specifying device that specifies locations of the plurality of wireless communication devices, and a plurality of wireless transmitting/receiving devices (e.g., access points) that are wirelessly connected to the plurality of wireless communication devices and that relay exchange of data between each wireless communication device and the location specifying device.

Each of the wireless communication devices has electric wave intensity measuring means (e.g., an electric wave intensity measuring section) for measuring the intensity of an electric wave received from each of the wireless transmitting/receiving devices, and transmitting electric wave intensity measurement data indicating measured intensity of the electric wave to the location specifying device via the wireless transmitting/receiving device, and the location specifying device has location specifying means (e.g., a communication device location specifying section) for calculating the locations of the plurality of wireless communication devices on the basis of the electric wave intensity measurement data.

Another aspect of the present invention is proposed as a communication device location specifying system for specifying a clerk who is in the best location to rush to a gaming machine calling for a clerk (the nearest position to the gaming machine, or a position in a pathway to reach the gaming machine most quickly), and causing the clerk to rush to the gaming machine.

This communication device location specifying system has a plurality of wireless communication devices (e.g., intercoms, mobile communication terminals, or the like), a location specifying device that specifies locations of the plurality of wireless communication devices, and a plurality of wireless transmitting/receiving devices (e.g., access points) that are wirelessly connected to the plurality of wireless communication devices and used for exchanging data between each wireless communication device and the location specifying device.

Each of the wireless transmitting/receiving devices has electric wave intensity measuring means (e.g., the electric wave intensity measuring section) for measuring the intensity of an electric wave received from each of the wireless communication devices, and transmitting electric wave intensity measurement data indicating the measured intensity of the electric wave to the location specifying device, and the location specifying device has location specifying means (e.g., the communication device location specifying section) for calculating the locations of the plurality of wireless communication devices on the basis of the electric wave intensity measurement data.

Furthermore, the communication device location specifying system may have the following characteristics. Specifically, the location specifying device is connected to calling means that is provided in a gaming machine or in the vicinity thereof and used by a game player to call out a clerk, and also, once receiving a call signal from the calling means, the location specifying device selects any one of the wireless communication devices in response to the calling means, and transmits a message to a selected wireless communication device.

Furthermore, the communication device location specifying system may have the following characteristics. Specifically, transmission/reception between the location specifying device and the selected wireless communication device is conducted by executing signaling processing.

Furthermore, the location specifying device may be configured to calculate locations of the wireless communication devices on the basis of the electric wave intensity measurement data, and select any one of the wireless communication devices on the basis of the location of the calling means and the location of each wireless communication device.

Still further, the location specifying device may be configured to calculate the distance between each of the plurality of wireless communication devices and the wireless transmitting/receiving devices on the basis of the electric wave intensity measurement data.

In addition, the location specifying device may also be configured to store the location of each of the plurality of wireless communication devices and the each calculated distance.

Furthermore, in the communication device location specifying system of the invention, processing for calculating the distance, processing for calculating the locations, and storage processing are executed each time when the location specifying device receives the electric wave intensity measurement data.

Yet another aspect of the present invention is proposed as a location specifying device. This location specifying device has: communication device location specifying means (e.g., the communication device location specifying section) for calculating locations of wireless communication devices (e.g., intercoms, mobile communication terminals, or the like) on the basis of electric wave intensity measurement data that indicates the intensity of an electric wave, data being received between each of the wireless communication devices and a wireless transmitting/receiving device (e.g., an access point); communication device selecting means (e.g., a communication device selecting section) for, once receiving a call signal that the game player sends to call out a clerk, comparing the locations of the wireless communication devices with a location corresponding to the call signal, and selecting a communication device located in a suitable location to rush to a gaming machine in response to the call signal; and selected communication device reporting means (a selected communication device reporting section) for sending a notification to the wireless communication device selected by the communication device selecting means.

Also, in the location specifying device described above, the communication device selecting means may be configured to determine an order of priorities for the wireless communication devices on the basis of the locations of the wireless communication devices, and if the selected wireless communication device does not perform a predetermined operation in response to the notification sent from the selected communication device reporting means, select a wireless communication device within this order of priorities. For example, in the case in which the wireless communication device of the first priority does not respond to a notification (e.g., a phone call) sent from the selected communication device reporting means, a wireless communication device of second or lower priority level is newly selected, and the notification is transmitted from the selected communication device reporting means to this newly selected wireless communication device. Here “predetermined operation” means sending a response indicating that the possessor of the wireless communication device rushes to the gaming machine in response to the notification, and thus means transmitting an “ACK” request.

For example, in the case in which call reception is rejected in the selected wireless communication device, the communication device selecting means may select another of the wireless communication devices within the order of priorities. Consequently, in the case where a clerk with a wireless communication device is already tied up with work, or in the case where a clerk cannot respond to a call due to misplacement of his/her wireless communication device or due to other reasons, a wireless communication device of second or lower priority level can be called out after calling out a predetermined number of times so as to send an effective clerk, by using such a location specifying device.

Also, in the location specifying device described above, the other wireless communication device may be of the next priority level of the priority order.

Moreover, the location specifying device described above may further have: location history storage means for storing a location history, which is information having clock times and the locations of wireless communication devices specified at the clock times; and monitoring means for determining, on a basis of the location history stored in the location history storage means, whether a predetermined condition is satisfied, and when determining that the predetermined condition is satisfied, then notifying a predetermined report destination of that the predetermined condition is satisfied.

Furthermore, in the location specifying device of the invention, each time when receiving the call signal, the communication device selecting means generates a table for determining a priority order for causing a clerk to rush to a gaming machine sending the call signal.

### BRIEF DESCRIPTION OF THE DRAWINGS

FIG. 1 is a block diagram showing an example of the configuration of a communication device location specifying system according to a first embodiment;

FIG. 2 is a functional block diagram showing an example of the configuration of a wireless communication device;

FIG. 3 is a functional block diagram showing an example of the configuration of a location specifying device;

FIG. 4 is a sequence diagram showing an example of the operation of the communication device location specifying system;

FIG. 5 is a block diagram showing an example of the configuration of the communication device location specifying system according to a second embodiment;

FIG. 6 is a figure showing an example of an order table for determining a priority order for the communication devices;

FIG. 7 is a block diagram showing an example of the configuration of the location specifying device according to a third embodiment;

FIG. 8 is a figure showing an example of a data configuration of a location history; and

FIG. 9 is a figure showing an example of a transmit pathway indicated by the location history.

### DESCRIPTION OF THE PREFERRED EMBODIMENTS

Embodiments of the present invention are described hereinafter with reference to the drawings.

### First Embodiment

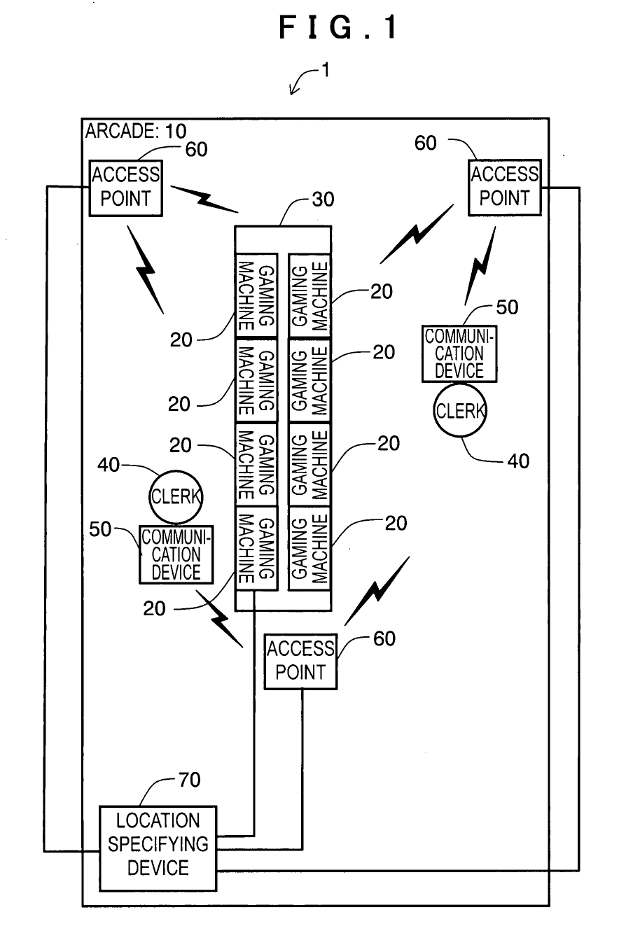

FIG. 1 is a schematic diagram of a communication device location specifying system according to a first embodiment of the present invention.

This communication device location specifying system 1 is a system used in an arcade 10 such as a game arcade, game center, casino or the like. A plurality of gaming machines 20 are set within the arcade 10. FIG. 1 shows a state in which the plurality of gaming machines 20 are installed on an isle 30 which is an installation board for the gaming machines. Each of the gaming machines 20 is provided with a calling device (e.g., an indicating device or the like provided with a call button; not shown). A game player (not shown) operates the calling device, whereby the communication device location specifying system 1 specifies a clerk 40 positioned nearby, and sends the clerk to the gaming machine 20 the calling device of which is operated.

The communication device location specifying system 1 has wireless communication devices (simply called “communication devices” hereinafter) 50 carried by clerks respectively, access points 60, which are wireless transmitting/receiving devices for exchanging data with the communication devices 50 wirelessly, and a location specifying device 70 that is connected to the access points 60 via LANs or networks. The location specifying device 70 is also connected to each of the gaming machine 20, specifically the calling device (not shown) provided in each gaming machine 20.

The communication device 50 is, for example, an intercom functioning as an IP phone. The communication device 50 is wirelessly connected to the access point 60. The access point 60 and the communication device 50 exchange data in accordance with IEEE 802.11a, IEEE 802.11b, IEEE 802.11g standards and the like.

The communication device 50 is also a device that functions as a user agent (UA), which is an entity for processing an SIP (Session Initiation Protocol) request, so as to function as an IP phone.

[1.1 Communication Device]

The communication device 50 has a function of, once it receives a wireless signal from the access points 60, measuring the intensity of an electric wave of the wireless signal for each access point 60, and notifying the location specifying device 70 of the measurement result through the access point 60.

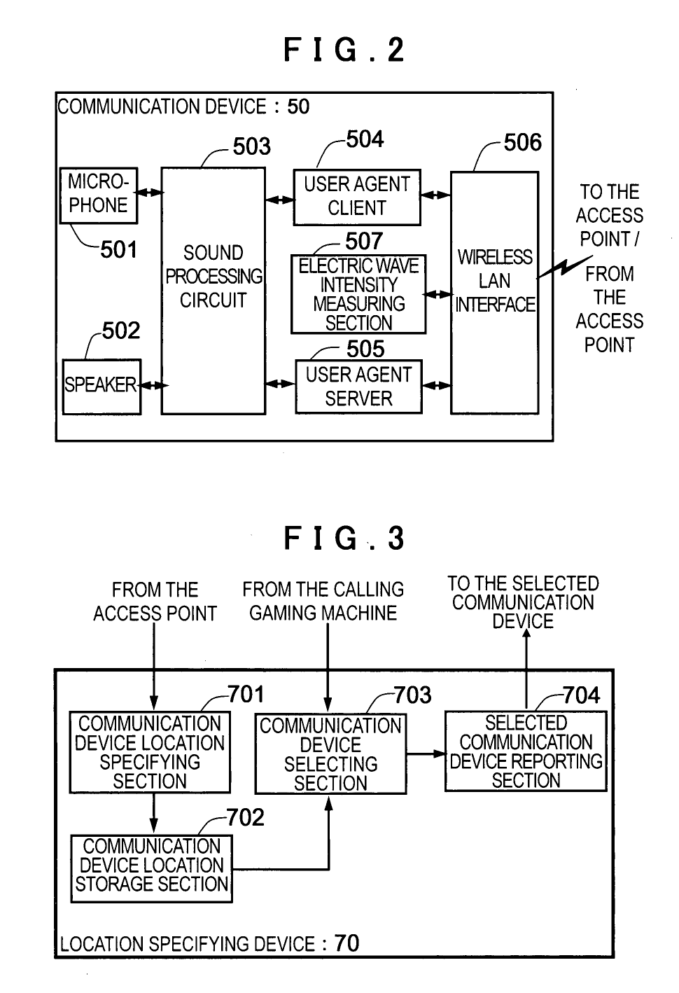

FIG. 2 is a functional block diagram showing an example of the configuration of a communication device 50. In the example shown in the figure, the communication device 50 has: a microphone 501 that converts sound into an electric signal; a speaker 502 that converts an electric signal into sound; a sound processing circuit 503 that converts an analog electric signal outputted from the microphone 501 into a digital signal, and further converts a digital signal into an analog signal to drive the speaker by means of the analog signal; a user agent client section 504 that generates and transmits an SIP request, and receives a response; a user agent server section 505 that receives/processes the SIP request and generates a response; a wireless LAN interface 506 that exchanges a wireless signal and data with the access points 60; and an electric wave intensity measuring section 507 that measures the intensity of an electric wave received from each access point 60, stores the electric wave intensity as electric wave intensity measurement data, and transmits the stored electric wave intensity measurement data to the location specifying device 70.

The communication devices 50 can communicate with each another via the location specifying device 70 that also functions as an SIP server, and can also be used as internal line terminals so that clerks can communicate with each other. Moreover, if, as a function of an SIP phone, one-to-many communication (e.g., simultaneously sending a message from a manager to all clerks) or many-to-many communication (e.g., a multipoint meeting in which all clerks participate) can be executed, the communication devices 50 can be used as terminals according to such function.

Also, by connecting the location specifying device 70 functioning as an SIP server to the location specifying device 70 of another arcade 10, the communication devices 50 used in the respective arcades 10 can communicate with one another, and thus can be used as the internal line terminals in the plurality of arcades.

[1.2 Access Point]

The access point 60 is a machine for connecting the communication device 50, which is a wireless LAN terminal, to the location specifying device 70 and relaying an electric wave. The location specifying device 70 and all communication devices 50 within a communication area of the access points 60 can be connected with one another via wireless LAN networks constructed by the access points 60.

[1.3 Location Specifying Device]

The location specifying device 70 receives the electric wave intensity measurement data from each of the communication devices 50, and performs location specifying processing for specifying the location of each communication device 50 on the basis of this electric wave intensity measurement data. Once receiving a call signal from a certain gaming machine 20, the location specifying device 70 selects a communication device 50 located in the best location to rush to the gaming machine 20, on the basis of the location of each communication device 50 obtained as a result of the location specifying processing, and transmits, to this communication device 50, a message to the effect that a clerk is sent to the gaming machine 20.

The location specifying device 70 also functions as a so-called SIP server. Specifically, the location specifying device 70 is an SIP entity that processes an SIP request and functions as: a proxy server that solves the next forwarding destination of an SIP request sent from the communication device 50 functioning as a user agent, and transfers the request; a redirect server that solves the next forwarding destination of an SIP request, and transmits this transfer destination; a server that receives a REGISTER request and registers a contact address of the communication device 50 which is a user agent; a user agent client; and a user agent server.

The location specifying device 70 is a device equipped with a central processing unit (CPU), main memory (RAM), read-only memory (ROM), input/output device (I/O), and if necessary, an external storage device such as a hard disk device or the like, and is also an information processing device such as a computer or a workstation. A program for causing the information processing device to function as the location specifying device 70, or a program for causing the computer to execute a communication device location specifying method is stored in the ROM, the hard disk device or the like. Such a program is mounted on the main memory, and the CPU executes this program, whereby the location specifying device 70 is realized, or the communication device location specifying method is executed. The program is not necessarily stored in the storage device within the information processing device, and thus may be provided by an external device (e.g., an ASP (a server of an application service provider)) and mounted on the main memory.

FIG. 3 is a functional block diagram showing an example of the configuration of the location specifying device 70.

The location specifying device 70 has a communication device location specifying section 701, a communication device location storage section 702, a communication device selecting section 703, and a selected communication device reporting section 704.

The communication device location specifying section 701 determines the locations of the communication devices 50 on the basis of the electric wave intensity measurement data received from each of the communication devices 50 via each of the access points 60. Since the locations of the communication devices 50 vary from hour to hour as the clerks carrying the communication devices 50 move, the communication device location specifying section 701 determines the locations of the communication devices 50, each time when receiving the electric wave intensity measurement data, to determine the latest locations. It should be noted that the locations of the communication devices 50 are not necessarily determined based on the information that is set as with a coordinate. For example, the arcade 10 may be divided into a plurality of small areas, and then by using information (the area number or the like) for specifying one of the areas that contains a communication device 50, the location of the communication device 50 may be determined. It should be noted that, in order to determine the location of the communication device 50 on the basis of the electric wave intensity measurement data, basically the distance between the communication device 50 and each access point 60 may be calculated from the electric wave intensity to obtain circles each having the access point 60 as the center and the calculated distance as the length of the radius, and then the intersection of the circles may be obtained. Furthermore, as an improved method of determining the locations, there is a location detection method for detecting a wireless mobile terminal, as disclosed in, for example, Japanese Unexamined Patent Publication No. 2002-159041. Thus such a method may be used to determine the locations of the communication devices 50.

The communication device location storage section 702 stores the location of each communication device 50 that is determined by the communication device location specifying section 701, updates the location of each communication device 50 to the latest location, each time when the communication device location specifying section 701 determines a new location of each communication device 50, and then stores the latest location.

Once receiving a call signal from a gaming machine 20, the communication device selecting section 703 specifies the location of the gaming machine 20 corresponding to the call signal (referred to as “calling gaming machine” hereinafter), then compares the location of each communication device 50 that is stored in the communication device location storage section 702, with the location of the calling gaming machine 20, and selects a communication device 50 that is in the suitable location to rush to the calling gaming machine 20. Any method can be used to determine which one of the communication devices 50 is located in the suitable location to rush to the gaming machine. For example, a method may be used in which a communication device 50 having the shortest distance (linear distance) with respect to the calling gaming machine 20 is selected, or, on the basis of the location of the calling gaming machine 20 and of each communication device 50, the length of a pathway that a clerk might take to rush to the calling gaming machine 20 may be calculated to select the communication device 50 from which the distance of the calling gaming machine 20 is the shortest. Also, the communication device location selecting section 703 may be used not only as a geographical condition such as the distance and pathway, but also as a condition for selecting whether the clerk carrying the communication device 50 at that point of time handles different work or not (provides a repair service to other gaming machine 20, etc.).

The selected communication device reporting section 704 sends, to the communication device 50 selected by the communication device selecting section 703 (referred to as “selected communication device 50” hereinafter), a notification to the effect that the call signal is received from the calling gaming machine 20. What kind of notification to send is arbitrary, thus the present invention does not limit the type of notification. In this embodiment, the selected communication device reporting section 704 is operated as a caller terminal of a so-called SIP phone (IP telephone), and calls out the selected communication device 50. In the case in which a session (connection) is established between the selected communication device reporting section 704 and the selected communication device 50, a voice message, such as “The gaming machine No. ooo is calling. Please respond”, is transmitted to the selected communication device 50 to prompt the clerk carrying this selected communication device 50 to rush to the calling gaming machine 20. It should be noted that the selected communication device reporting section 704 stores destination information of each communication device 50 (URI, phone number, etc.), thus, once a communication device 50 is specified, the destination information thereof can be used to perform communication with the selected communication device reporting section 704.

[Operation Example of the Present System]

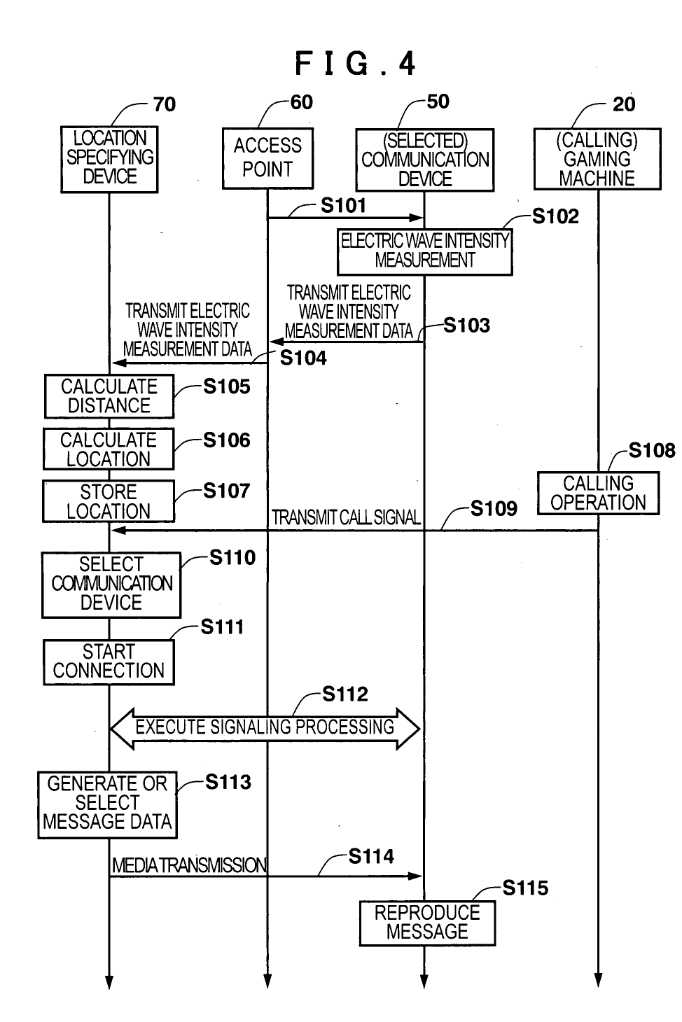

Next, an example of the operation of the communication device location specifying system 1 according to the present embodiment is described with reference to FIG. 4. FIG. 4 is a sequence diagram showing an example of the operation of the communication device location specifying system 1. It should be noted that FIG. 4 shows one access point 60 and one communication device 50, thus illustration of the rest of the access points 60 and communication devices 50 is omitted.

First of all, each of the access points 60 transmits an electric wave to each of the communication devices 50 (step S101). This electric wave may be a beacon that is transmitted regularly by each access point 60, or may be an electric wave used for any other purposes.

Each communication device 50 that receives the electric wave from each access point 60, more particularly the electric wave intensity measuring section 507, measures electric wave intensity for each access point 60 (step S102), and stores the result of measurement as the electric wave intensity measurement data.

Next, each communication device 50 transmits the electric wave intensity measurement data stored therein to the location specifying device 70 via the connected access point 60 (steps S103 and S104).

The location specifying device 70 that receives the electric wave intensity measurement data from each communication device 50, more particularly the communication device location specifying section 701, executes distance calculation, which is a process for calculating the distance between each communication device 50 transmitting the electric wave intensity measurement data and each access point 60 on the basis of each electric wave intensity measurement data item (step S105). This distance calculation is performed for each communication device 50.

Moreover, the location specifying device 70, more particularly the communication device location specifying section 701, carries out location calculation, which is a process for calculating the location of each communication device 50 on the basis of the distance between the communication device 50 and each access point 60, the distance being obtained in the distance calculation (step S106). This location calculation also is performed for each communication device 50. The location of each communication device 50 is specified by means of these processing.

Subsequently, the location specifying device 70, more particularly the communication device location storage section 702, performs location storage, which is a process for storing the location of each communication device 50, which is specified by the processing of S105, S106 (step S107). It should be noted that the processing steps S105 through S107 are executed each time when the electric wave intensity measurement data is received, and it is preferred that the location of each communication device 50 be constantly brought to up-to-date.

It should be noted that the processing of the steps S101 through S107 are performed repeatedly.

Now, suppose that a game payer playing a game on a certain gaming machine 20 operates the calling device installed in the gaming machine (step S108), to request a clerk (staff) for some kind of a service (e.g., to resolve a trouble of ball clogging).

In response to this calling operation, the calling gaming machine 20 transmits a call signal to the location specifying device 70 (step S1109).

The location specifying device 70 that receives the call signal, more particularly the communication device selecting section 703, compares, in the step S107, the location of each communication device 50, which is stored in the communication device location storage section 702, with the location of the calling gaming machine 20, which is the source of transmission of the call signal, and selects a communication device 50 that is located in a suitable location to rush to the calling gaming machine 20. The communication device selecting section 703 then sends the information specifying the selected communication device 50 to the selected communication device reporting section 704.

The selected communication device reporting section 704 that receives the information specifying the selected communication device 50 sends a call to the selected communication device 50, and carries out connection start, which is a process for attempting to make a communication connection (step S111). Specifically, signaling processing for exchanging a method (request) according to a predetermined protocol between the selected communication device reporting section 704 and the selected communication device 50 is executed (step S112). Specifically, the selected communication device reporting section 704 transmits “INVITE”, which is an SIP message, to the selected communication device 50. Next, once receiving “180 Ringing” and “200 OK” from the selected communication device 50 in response, the selected communication device reporting section 704 transmits “ACK” to the selected communication device 50, whereby a connection therebetween is established.

Once a connection is established, generation and selection of message data is executed by the location specifying device 70 (step S113). Then, the selected communication device reporting section 704 of the location specifying device 70 transmits a voice message (the above-mentioned message data), such as “The gaming machine No. ooo is calling. Please respond”, to the selected communication device 50 (step S114). Transmission of this voice message is performed by transmitting a voice packet from the location specifying device 70 to the selected communication device 50 on the basis of an arbitrary protocol such as an RTP (real-time transport protocol).

The selected communication device 50 that receives this voice message reproduces the voice message (step S115). The reproduced voice message is outputted from the speaker 502. In response to a message, “The gaming machine No. ooo is calling. Please respond”, the clerk carrying the selected communication device 50 rushes to the calling gaming machine 20, and provides a requested service.

[Modifications etc.]

(1) The above-described embodiment is configured such that a communication device 50 is caused to measure the electric wave intensity for calculating the distance between an access point 60 and the communication device 50. However, the present invention is realized even if the embodiment is configured such that an access point 60 is caused to measure the electric wave intensity for calculating the distance between the access point 60 and communication device 50, and to transmit, to the location specifying device 70, the electric wave intensity measurement data obtained as a result of the measurement. Specifically, each access point 60 measures the intensity of a received electric wave for each communication device 50 located within the reception allowable area, and transmits the intensity as the electric wave intensity measurement data to the location specifying device 70. The location specifying device 70 may calculate the distance between each access point 60 and communication device 50 on the basis of the electric wave intensity measurement data received from each access point 60.

According to the first embodiment described above, the location of each wireless communication device is managed on the basis of the intensity of an electric wave that each wireless communication device receives from each wireless transmitting/receiving device, and, as a result, the location of each clerk carrying the wireless communication device can also be managed. Then, in the case in which a certain gaming machine sends a call, the most efficient clerk to send to the calling gaming machine is determined on the basis of the location of each clerk. Accordingly, a situation in which a plurality of workers are sent to the same gaming machine can be prevented from happening, operating efficiency of the clerks can be improved, and the quickest response to a call-out is made possible, whereby the customer service can be improved.

### Second Embodiment

Next, the communication device location specifying system according a second embodiment of the present invention is described. The communication device location specifying system 1 according to the second embodiment is characterized in that an order of priorities for the gaming machines calling the communication devices 50 is determined in advance, and that the communication devices 50 are called in accordance with the order of priorities. The configuration of the communication device location specifying system 1, the configuration of the communication devices 50, the configuration of the location specifying device 70, and the main operation of the communication device location specifying system 1 are the same as those described in the first embodiment (see FIG. 1 through FIG. 4).

Specifically, in the case in which the location specifying device 70 receives a call signal from a calling gaming machine 20, the location specifying device 70 determines an order of priorities for the communication devices 50 that are sent to the calling gaming machine 20, and, first, sends a call to the communication device 50 of the first priority to attempt a communication connection. In the case in which the communication device 50 of the first priority responds and communication connection is established, the message for causing the clerk to rush to the calling gaming machine is transmitted to this communication device 50, as in the manner described in the first embodiment. On the other hand, in the case in which the communication device 50 of the first priority cannot or does not respond to this call, i.e., in the case in which the line is busy, or in the case in which the clerk 40 does not respond to the call even when calls are made a predetermined number of times, the location specifying device 70 sends a call to the communication device 50 of the next priority (second priority) level to attempt a communication connection. Subsequently, a communication connection to each communication device 50 is attempted in accordance with the priority order, until a communication connection is established.

According to the second embodiment, in the case in which the location specifying device 70 is connected to a communication device 50 to instruct the clerk to rush to the calling gaming machine 20, a clerk among the other clerks, who is expected to be able to rush to the calling gaming machine 20 most promptly, can be instructed to rush to the calling gaming machine 20 even when the communication device 50 does not or cannot respond to the call.

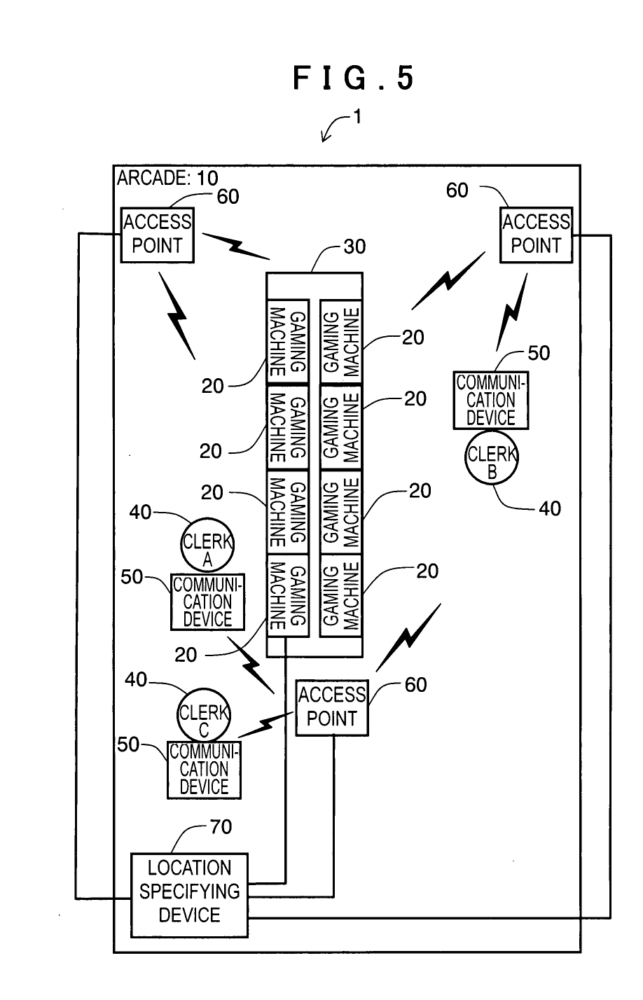

FIG. 5 is a figure showing an example of the communication device location specifying system 1 according to the second embodiment. Three clerks A, B and C are positioned in different places in the arcade 10. Now, a call signal is transmitted from a certain gaming machine 20, and the location specifying device 70 performs processing for instructing a communication device 50 to rush to the calling gaming machine 20, in response to this call signal.

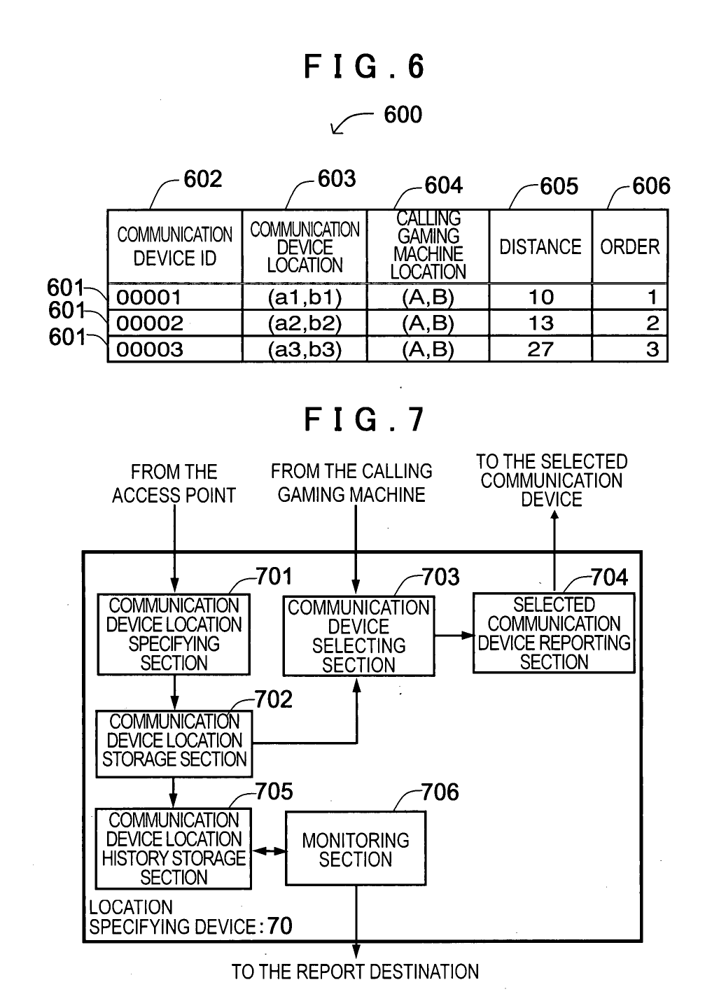

FIG. 6 shows an example of data that is generated and then stored by the location specifying device 70 of the second embodiment, more particularly the communication device selecting section 703, in order to perform the processing for instructing the communication device 50 to rush to the calling gaming machine 20.

Once receiving a call signal, the location specifying device 70, more particularly the communication device selecting section 703, generates an order table 600 for determining a priority order for causing a communication device to rush to the calling gaming machine 20. This order table 600 is generated each time when a call signal is received.

The order table 600 has one record 601 for each communication device 50. Each record 601 has a communication device ID field 602, a communication device location field 603, a calling gaming machine location field 604, a distance field 605, and an order field 606.

Information for uniquely specifying a communication device 50, e.g., a communication device ID, phone number, URI or the like, is stored in the communication device ID field 602.

The location information on the communication device 50 is stored in the communication device location field 603. As the location information, the latest location information stored in the communication device location storage section 702 is stored. The location information on the calling gaming machine 20 (e.g., a coordinate) is stored in the calling gaming machine location field 604.

The distance field 605 stores the distance between the calling gaming machine 20 and the communication device 50, which is calculated on the basis of the location information stored in the communication device location field 603 of the record and the location information on the calling gaming machine 20 stored in the calling gaming machine location field 604 of the record.

An order that is determined on the basis of the distance stored in the distance field 605 is stored in the order field 606. Here, the communication device having the shortest distance is determined as the number one priority, and the second priority level, third priority level, etc. are subsequently determined in the order of distance from the shortest to the farthest. Therefore, the communication device 50 located in the shortest distance to the calling gaming machine 20 receives a call from the location specifying device 70 preferentially.

According to such communication device location specifying system 1, as to a communication device 50 that is first requested to rush to the calling gaming machine 20, if the clerk 40 of this communication device 50 cannot rush to the gaming machine for some reason, a clerk 40 of subsequent priority, who is a next effective clerk to rush to the calling gaming machine 20, can be requested to rush to the calling gaming machine 20, whereby a prompt and appropriate response is made possible in response to a request from the game player.

### Third Embodiment

Next, a third embodiment of the present invention is described.

The communication device location specifying system 1 according to the third embodiment is characterized in acquiring a location history of each communication device 50 (a record of a change of the location information as time passes), and transmitting a notification under predetermined conditions on the basis of this location history.

Generally, the owner, manager, and operator monitor a location history of the arcade manager and clerk and wish to discover an inappropriate action. For example, in those accidents that happen in a game arcade or the like, there are quite a few incidents where a person involved in the game arcade conspires with his collaborator to perform some action. Also, there is usually a large amount of money in the arcade. These are some of the reasons that behaviors of the clerks are managed/monitored.

By using location histories generated by the present system 1, the following suspicious manners of, for example, a possessor of a communication device 50 (a clerk, the arcade manager or the like), can be detected.

1) A communication device is absent from the arcade without permission during business hours.

2) A communication device does not come out of a bathroom for over 30 minutes.

3) A communication device enters an area (safe-deposit vault) authorized only to the manager (arcade manager).

4) A communication device enters a storehouse without permission.

The communication device location specifying system 1 records a location history of each communication device 50 on a regular basis. In the case in which the location history satisfies a predetermined condition indicating the above suspicious behaviors (e.g., in the case in which the communication device 50 remains in a predetermined area, such as outside of the arcade, the safe-deposit vault, storehouse or the like, for a predetermined period of time or more), a notification is transmitted to a predetermined report destination (e.g., a cellular phone of the arcade owner).

The configurations of the communication device location specifying system 1 and the communication devices 50 according to the third embodiment are the same as those described in the first and second embodiments.

FIG. 7 shows an example of the configuration of the location specifying device 70 according to the third embodiment. FIG. 7 is a functional block diagram showing an example of the configuration of the location specifying device 70.

As with the location specifying devices according to the first and second embodiments, the location specifying device 70 has the communication device location specifying section 701, communication device location storage section 702, communication device selecting section 703, and selected communication device reporting section 704. The location specifying device 70 further has a communication device location history storage section 705 that is connected to the communication device location storage section 702, and a monitoring section 706 that is connected to the communication device location history storage section 705.

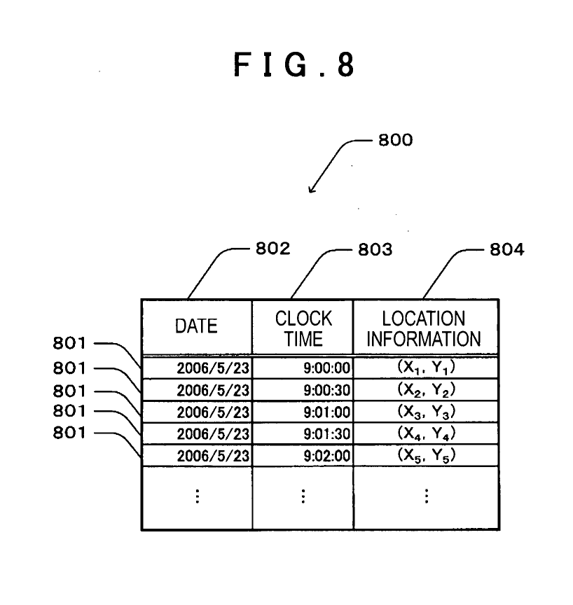

The communication device location history storage section 705 generates a location history of each communication device 50, which is information associating time with the location information obtained at that time, and stores this information. FIG. 8 shows an example of a data configuration of the location history generated by the communication device location history storage section 705.

In the present embodiment, the location history is generated as one location history table for one communication device 50, and is then stored. A location history table 800 has one record 801 for each clock time. In this example, a location is stored every 30 seconds, thus one record 801 is created every 30 seconds.

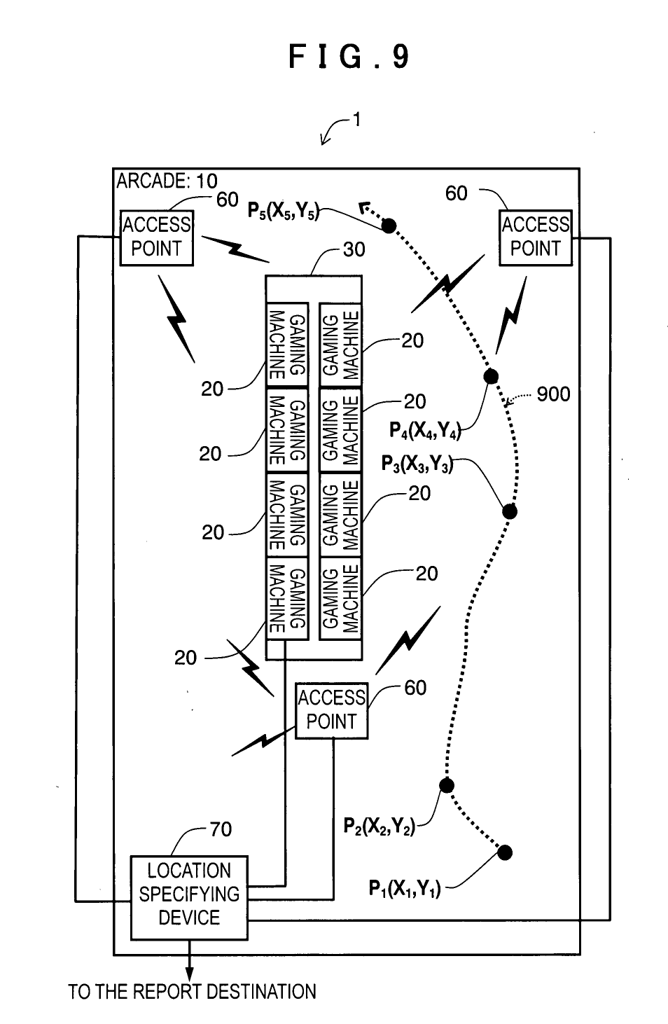

Each record 801 has a date field 802, a clock time field 803, and a location information field 804. Dates are stored in the date field 802, and clock times are stored in the clock time field 803. The location information (e.g., a coordinate) on the communication device 50 specified on the corresponding date and clock time is stored in the location information field 804. The example shown in the figure shows that the communication device 50 corresponding to this location history table 800 transmits via positions (X1, Y1), (X2, Y2), (X3, Y3), (X4, Y4) and (X5, Y5) sequentially between “9:00:00 AM on May 23, 2006” and “9:02:00 AM on May 23, 2006”. FIG. 9 is a figure showing a transmit pathway corresponding to the transfer history shown in FIG. 8. In the figure, a transmit pathway 900 shows a pathway along which the communication device 50 actually moves. Passing points P1, P2, P3, P4 and P5 on the transmit pathway correspond to the coordinates (X1, Y1), (X2, Y2), (X3, Y3), (X4, Y4) and (X5, Y5) stored by the location specifying device 70. The transmit pathway of the communication device 50 can be specified by reference to the location history thereof, and behavior of a user of the communication device 50 can also be estimated.

According to the third embodiment described above, the location of each wireless communication device can be managed, and as a result the location of each clerk carrying the wireless communication device can also be managed. When there is a call from a certain gaming machine, the most efficient clerk to send to the calling gaming machine is determined on the basis of the location of each clerk. As a result, a situation in which a plurality of workers are sent to the same gaming machine can be prevented from happening, operating efficiency of the clerks can be improved, and the quickest response to a call-out is made possible, whereby the customer service can be improved.

Returning to FIG. 7, the example of the configuration of the location specifying device 70 is further explained. The monitoring section 706 determines whether there is generated a situation where a notification should be sent to a predetermined person such as an arcade owner, on the basis of the location history stored in the communication device location history storage section 705. For example, the situation where a notification should be sent means, for example, a situation where a communication device stays in a restricted area for a predetermined period of time or longer. When the monitoring section 706 determines that there is generated the situation where a notification should be sent, the monitoring section 706 transmits a notification to a predetermined report destination (e.g., a cellular phone of the owner, a monitoring PC, etc.). For example, the monitoring section 706 generates an e-mail having a message content, such as “a suspicious situation is generated,” and transmits this e-mail to the cellular phone of the owner.

Furthermore, a method of using a saved location history (to specify a person who approaches a gaming machine 20 on which an inappropriate action occurs) is also possible.

In this manner, according to the location specifying device of the present embodiment, behavior of a clerk and the like can be managed/monitored while using a communication device to perform communication with other communication devices, and an inappropriate action can be discovered, inhibited, and examined.

As described above, the communication device location specifying system and the location specifying device according to the present embodiment can specify a clerk who is in the best location to rush to a gaming machine calling for a clerk (the nearest position to the gaming machine, or a position in a pathway to reach the gaming machine most quickly), and cause the clerk to rush to the gaming machine.

What is claimed is:

1. A communication device location specifying system, comprising:
a plurality of wireless communication devices;
a location specifying device that specifies locations of the plurality of wireless communication devices; and
a plurality of wireless transmitting/receiving devices that are wirelessly connected to the plurality of wireless communication devices and that relay exchange of data between each wireless communication device and the location specifying device, wherein
each of the wireless communication devices has an electric wave intensity measuring section that measures the intensity of an electric wave received from each of the wireless transmitting/receiving devices, and transmits electric wave intensity measurement data indicating measured intensity of the electric wave to the location specifying device via the wireless transmitting/receiving device, and
the location specifying device has a location specifying section that calculates the locations of the plurality of wireless communication devices on the basis of the electric wave intensity measurement data.

2. The communication device location specifying system according to claim 1, wherein
the location specifying device is connected to a calling section that is provided in a gaming machine or in the vicinity thereof and used by a game player to call out a clerk, and
once receiving a call signal from the calling section, the location specifying device selects any one of the wireless communication devices in response to the calling section, and transmits a message to a selected wireless communication device.

3. The communication device location specifying system according to claim 2, wherein transmission/reception between the location specifying device and the selected wireless communication device is conducted by executing signaling processing.

4. The communication device location specifying system according to claim 2, wherein the location specifying device calculates locations of the wireless communication devices on the basis of the electric wave intensity measurement data, and selects any one of the wireless communication devices on the basis of the location of the calling section and the locations of the wireless communication devices.

5. The communication device location specifying system according to claim 1, wherein the location specifying device calculates the distance between each of the plurality of wireless communication devices and the wireless transmitting/receiving devices on the basis of the electric wave intensity measurement data.

6. The communication device location specifying system according to claim 5, wherein the location specifying device stores the location of each of the plurality of wireless communication devices and the each calculated distance.

7. The communication device location specifying system according to claim 6, wherein processing for calculating the distance, processing for calculating the locations, and storage processing are executed each time when the location specifying device receives the electric wave intensity measurement data.

8. A communication device location specifying system, comprising:
a plurality of wireless communication devices;
a location specifying device that specifies locations of the plurality of wireless communication devices; and
a plurality of wireless transmitting/receiving devices that are wirelessly connected to the plurality of wireless communication devices and are used for exchanging data between each wireless communication device and the location specifying device, wherein
each of the wireless transmitting/receiving devices has an electric wave intensity measuring section that measures the intensity of an electric wave received from each of the wireless communication devices, and transmits electric wave intensity measurement data indicating the measured intensity of the electric wave to the location specifying device, and
the location specifying device has a location specifying section that calculates the locations of the plurality of wireless communication devices on the basis of the electric wave intensity measurement data.

9. The communication device location specifying system according to claim 8, wherein
the location specifying device is connected to a calling section that is provided in a gaming machine or in a vicinity thereof and used by a game player to call out a clerk, and
once receiving a call signal from the calling section, the location specifying device selects any one of the wireless communication devices in response to the calling section, and transmits a message to the selected wireless communication device.

10. The communication device location specifying system according to claim 9, wherein transmission/reception between the location specifying device and the selected wireless communication device is conducted by executing signaling processing.

11. The communication device location specifying system according to claim 9, wherein the location specifying device calculates the locations of the wireless communication devices on the basis of the electric wave intensity measurement data, and selects any one of the wireless communication devices on the basis of the location of the calling section and locations of the wireless communication devices.

12. The communication device location specifying system according to claim 8, wherein the location specifying device calculates distance between each of the plurality of wireless communication devices and the wireless transmitting/receiving devices on the basis of the electric wave intensity measurement data.

13. The communication device location specifying system according to claim 12, wherein the location specifying device stores the location of each of the plurality of wireless communication devices and each calculated distance.

14. The communication device location specifying system according to claim 13, wherein processing for calculating the distance, processing for calculating the locations, and storage processing are executed each time when the location specifying device receives the electric wave intensity measurement data.

15. A location specifying device, comprising:
a communication device location specifying section that calculates locations of wireless communication devices on the basis of electric wave intensity measurement data that indicates the intensity of an electric wave, data being received between each of the wireless communication devices and a wireless transmitting/receiving device;
a communication device selecting section that, once receiving a call signal that a game player sends to call out a clerk, compares the locations of the wireless communication devices with a location corresponding to the call signal, and selects a wireless communication device located in a suitable location to rush to a gaming machine in response to the call signal; and
a selected communication device reporting section that sends a notification to the wireless communication device selected by the communication device selecting section.

16. The location specifying device according to claim 15, wherein the communication device selecting section determines an order of priorities for the wireless communication devices on the basis of the locations of the wireless communication devices, and if the selected wireless communication device does not perform a predetermined operation in response to the notification sent from the selected communication device reporting section, selects another of the wireless communication devices within the order of priorities.

17. The location specifying device according to claim 15, wherein in the case in which call reception is rejected in the selected wireless communication device, the communication device selecting section selects another of the wireless communication devices within the order of priorities.

18. The location specifying device according to claim 15, wherein, the other wireless communication device is of the next priority level of the priority order.

19. The location specifying device according to claim 15, further comprising:
a location history storage section that stores a location history, which is information having clock times and locations of the wireless communication devices specified at the clock times; and
a monitoring section that determines, on a basis of the location history stored in the location history storage section, whether a predetermined condition is satisfied, and when determining that the predetermined condition is satisfied, then notifies a predetermined report destination of that the predetermined condition is satisfied.

20. The location specifying device according to claim 18, wherein, each time when receiving the call signal, the communication device selecting section generates a table for determining a priority order for causing a clerk to rush to a gaming machine sending the call signal.
